(19) United States
(12) Patent Application Publication
(10) Pub. No.: US 2020/0263847 A1
(43) Pub. Date: Aug. 20, 2020

(54) COMMUNICATIONS SYSTEM FOR A MOTOR VEHICLE

(71) Applicant: Hella GmbH & Co. KGaA, Lippstadt (DE)

(72) Inventors: Mathias Drüppel, Lippstadt (DE); David Duhme, Lippetal (DE); Kai Ehlert, Büren (DE); Bernd Fischer, Altenbeken (DE); Julien Hansen, Delmenhorst (DE); Marc Kaup, Paderborn (DE); Lukas Pörtner, Witten (DE); Claas Tebrügge, Rhede (DE); Benjamin Willeke, Paderborn (DE); Jan-Henning Willrodt, Hamburg (DE)

(21) Appl. No.: 16/754,594

(22) PCT Filed: Oct. 2, 2018
(86) PCT No.: PCT/EP2018/076742

§ 371 Date: Apr. 8, 2020

(30) Foreign Application Priority Data
Oct. 12, 2017 (DE) 10 2017 123 720.8

(51) Int. Cl. F21S 41/24; B60Q 1/00; F21S 41/141; F21S 41/16; H04B 10/116; F21S 41/125

(52) U.S. Cl. CPC F21S 41/24; B60Q 1/0017; F21S 41/125; F21S 41/16; H04B 10/116; F21S 41/141

(57) ABSTRACT

Communications system for motor vehicles are provided, that comprise a plurality of transmission devices and a plurality of receiver devices where the transmission devices, individually or together, feature several light sources that are able to emit at least light with a first wavelength spectrum and light with a second wavelength spectrum. The transmission devices feature means of modulation that can effect modulation of the light such that information can be transmitted via the light. Receiver devices can capture the emitted light and extract the information from the captured light. The communications system is designed in such a way that the light with the first wavelength spectrum is used for the transmission of information in a first category and the light with the second wavelength spectrum is used for the transmission of information in a second category.

### CROSS REFERENCE

This application claims priority to PCT Application No. PCT/EP2018/076742, filed Oct. 2, 2018, which itself claims priority to German Application No. 10 2017 123720.8, filed Oct. 12, 2017, the entirety of both of which are hereby incorporated by reference.

### FIELD OF THE INVENTION

The present invention relates to a communications system for motor vehicles according to the preamble of claim 1 as well as a transmission device for such a communications system according to the preamble of claim 6 and a receiver device for such a communications system.

### BACKGROUND

A communications system, a transmission device and a receiver device of the aforementioned kind are known from DE 10 2006 030 878 A1. The transmission device acting as illumination device described therein provides for a plurality of light sources that in particular take the form of different colored light emitting diodes (LEDs). Each one of the light emitting diodes is actuated by its own driver circuit. A data signal is divided up by a multiplexer into several voltage signals that are guided to the drivers. In the process, such a modulation of the voltage signals is ensured that the light emitted by the several light sources gives rise to the impression of white light on the object to be illuminated. The data can be extracted from the light emitted by the transmission device by means of a corresponding receiver device.

One detrimental factor can be seen in the fact that communication services relevant to safety could be blocked for example by a data transmission for entertainment purposes.

The problem underlying the present invention is to create a communications system of the kind described at the beginning of this document in which the transmission of important information is not prevented or slowed down by the transmission of unimportant information. Furthermore, a transmission device and a receiver device for a communications system of such a kind are to be specified.

### SUMMARY OF THE INVENTION

In accordance with the invention, this is achieved by a communications system of the kind named at the beginning of this document with the characteristic features of claim 1 as well as by means of a transmission device of the kind named at the beginning of this document with the characteristic features of claim 6 and a receiver device with the features of claim 10. The subclaims related to preferred embodiments of the invention.

In accordance with claim 1, it is provided that the communications system is designed in such a way that the light with the first wave length spectrum is used for the transmission of information in a first category and the light with the second wave length spectrum is used for transmission of information in a second category. In this way, it is possible to separate the transmission of different categories of information or to separate different communication services from each in an effective manner using simple means. The use of different wavelength spectra or different light colors for different categories of information means that additional negotiation of resources is no longer necessary. For the transmission of important information, there is light available in a wavelength spectrum or of a light color that is not used for the transmission of information serving entertainment purposes, for example. By doing so, in particular those channel resources for data relevant to safety are not blocked by other services.

It may be provided that the first category and the second category as well as any at least one further category relate to warnings and/or sensor data and/or traffic data and/or infotainment and/or entertainment. It is quite possible to subdivide that data into further categories and to allocate further categories to additional light colors or wavelength spectra.

There is the possibility for the light with a first wavelength spectrum to be red light, for the light with a second wavelength spectrum is to be green light and for the light with a third wavelength spectrum to be blue light. For example, blue light could then be used for the transmission of warnings, red light for the transmission of sensor data and/or traffic data and green light for the transmission of infotainment and/or entertainment. Other allocations are possible.

According to claim 6, it is provided for the transmission device to be designed in such a way that the light from the at least one light source is modulated for information transmission only when the information to be transmitted belongs to the category corresponding to the wavelength spectrum of the light from the at least one light source.

It can be provided for the at least one light source to take the form of a light emitting diode (LED) or of a laser, in particular of a semiconductor laser. For example, the transmission device can comprise several light sources, in particular three light sources, where during operation of the transmission device one of the first light sources preferentially transmits red light, one of the second light sources preferentially transmits green light and one of the third light sources preferentially transmits blue light.

Furthermore, it can be provided that the transmission device comprises means of mixing the light emitted by the individual light sources such that during operation of the transmission device white light is emitted by the transmission device. In this way, white light is created by overlapping already in or in the area of the transmission device so that an observer viewing the transmission device perceives a white light source.

A transmission device with light sources for red, green and blue light can preferentially support all services or the transmission of information in all categories. In doing so, in particular only those color portions are modulated that are intended for the respective task. The unused color portions shine unmodulated in order to maintain the impression of the color white.

There is the possibility of the means of mixing the light emitted from the individual light sources to comprise a fiber coupler that, during operation of the transmission device, pools the light from the three light sources, where in particular several optical fibers are provided through which the light from each of the light sources arrives at the fiber coupler. In this context, the exit aperture of the fiber coupler or the exit aperture of an optical fiber connected on the output side to the fiber coupler can be arranged within the transmission device. The fiber coupler is used to mix in an efficient and virtually loss-free manner, the light portions of the light sources, where only little installation space is needed.

It can be provided for the transmission device to comprise means of control that, depending on the category of the information to be transmitted, can modulate and encode a voltage signal for actuating the light source allocated to the corresponding category.

According to claim 10, an inventive receiver device comprises sensor means that can capture separately the light emitted by the at least one light source of the transmission device, in particular the light emitted by light sources with different wavelength spectra as well as evaluation means that are able to extract from the captured light the information transmitted, in particular by means of demodulation and decoding. In this respect, it is also possible to use a larger number of sensor means, in particular photodiodes, in order to capture or locally resolve a larger area.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic view of an inventive transmission device.

FIG. 2 is a schematic view of an inventive receiver device.

### DETAILED DESCRIPTION OF THE DRAWINGS

In the figures, identical and functionally identical parts have the same reference signs.

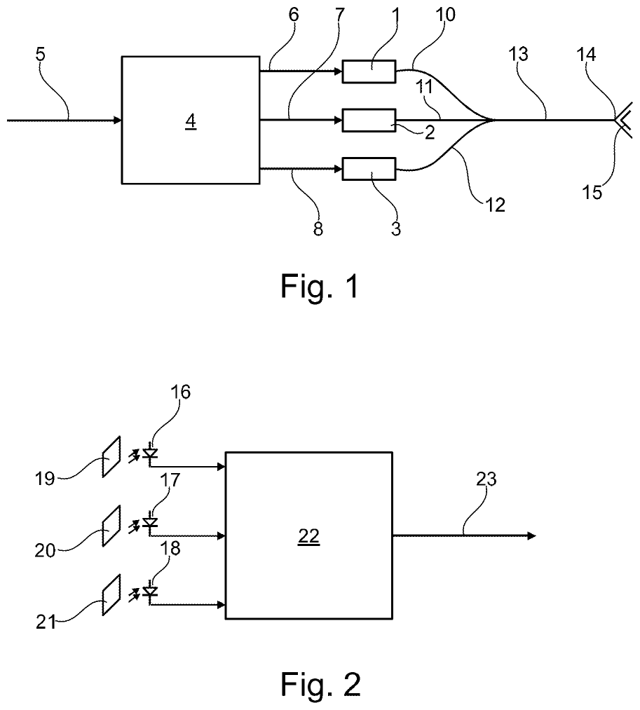

The embodiment of an inventive transmission device that can be seen from FIG. 1 can, for example, take the form of a headlamp, where only parts of the headlamp are shown.

The embodiment of the transmission device comprises three light sources 1, 2, 3 that feature different wavelength spectra. In this context, for example, the light source 1 can emit red-colored light, the light source 2 can emit green-colored light and the light source 3 can emit blue-colored light.

The light sources 1, 2, 3 can, in particular, take the form of light emitting diodes (LEDs). There is, however, also the possibility for the light sources 1, 2, 3 to take the form of lasers, preferentially laser diodes.

The transmission device further comprises means of modulation and means of encoding that are combined in one component 4. The means of modulation and the means of encoding can use a data signal 5, that is, for example, output by the onboard computer of a motor vehicle, to modulate and encode a voltage signal 6, 7, 8 for actuation of the light sources 1, 2, 3.

Furthermore, the component 4 can also provide for means of control that, depending on the category of the information in the data signal to be transmitted, modulate and encode the voltage signal 6, 7, 8 for the corresponding light sources 1, 2, 3. For example, when a warning is to be transmitted, the voltage signal 8 for the light source 3 that emits blue-colored light can be modulated and encoded for information transmission. For example, when sensor data or traffic data are to be transmitted, the voltage signal 6 for the light source 1 that emits red-colored light can be modulated and encoded for information transmission. For example, when infotainment is to be transmitted, the voltage signal 7 for the light source 2 that emits green-colored light can be modulated and encoded for information transmission.

In this respect, the modulation scheme and the encoding scheme can be selected such that the light emitted by the light emitting diodes 1, 2, 3 in its entirety gives the impression of white light. With the modulation of the individual voltage signals 6, 7, 8, the frequency can be selected such that the human eye sees a constant intensity. If information is to be transmitted via only one of the color channels, the voltage signals 6, 7, 8 are not modulated for the other channels so that the corresponding light sources 1, 2, 3, shine unmodulated in order to maintain the impression of the color white.

The transmission device comprises, as the means of mixing the light emitted by the individual light sources 1, 2, 3, a fiber coupler 9 and three optical fibers 10, 11, 12 that link the light sources 1, 2, 3 with the fiber coupler 9. The light emitted by the three light sources 1, 2, 3 is mixed by the fiber coupler 9 resulting in white light. The transmission device further comprises an optical fiber 13 exiting from the fiber coupler 9 on the output side from the exit aperture 14 of which white light 15 is emitted.

The light emitted by the transmission device can be used both for illumination purposes and for communication between vehicles.

The embodiment shown in FIG. 2 of an inventive receiver device comprises three photodiodes 16, 17, 18 acting as sensor means in front of each of which a color filter 19, 20, 21 is arranged. It is also possible to use a larger number of photodiodes in order to capture or locally resolve a larger area.

The color filters 19, 20, 21 divide the light into the channels corresponding to the three colors. In doing so, it is possible for the light to be demodulated and decoded in the evaluation means 22 linked to the photodiodes 16, 17, 18. In the evaluation means 22, the individual voltage signals can, if necessary, be amplified prior to demodulation and decoding. The demodulated and decoded signals can be compounded into a data signal 23 that can be further processed.

The receiver device can, for example, be arranged in a motor vehicle that is driving in front of the motor vehicle with the inventive transmission device.

### LIST OF REFERENCE SIGNS

1, 2, 3 Light source
4 Component with means of modulation and means of encoding
5 Data signal
6, 7, 8 Voltage signal
9 Fiber coupler 10,
11, 12 Optical fiber
13 Optical fiber
14 Exit aperture
15 White light 16, 17,
18 Photodiode 19,
20, 21 Color filter
22 Evaluation means
23 Data signal

1. A communications system for motor vehicles, the system comprising:
a plurality of transmission devices, for sending out individually or together, at least light with a first wave length spectrum and light with a second wave length spectrum, said plurality of transmission devices including a means of modulation that effects modulation of the light such that information can be transmitted by means of the light;
a plurality of receiver devices that capture the emitted light and extract from the captured light the transmitted information,
wherein the light with the first wave length spectrum is used for the transmission of information in a first category and the light with the second wave length spectrum is used for transmission of information in a second category.

2. The communications system in accordance with claim 1, wherein light with a third wavelength spectrum is used for the transmission of information in a third category.

3. The communications system in accordance with claim 1, wherein the first category and the second category as well as any at least one further category are related to at least one of warnings and sensor data and traffic data and infotainment and/or entertainment.

4. The communications system in accordance with claim 2, wherein the light with a first wavelength spectrum is red light, the light with a second wavelength spectrum is green light and the light with a third wavelength spectrum is blue light.

5. The communications system in accordance with claim 2, wherein blue light is used for the transmission of warnings, red light is used for the transmission of at least one of sensor data and traffic data, and green light is used for the transmission of Infotainment and/or entertainment.

6. A transmission device for a communications system, the transmission device comprising
at least one light source that emits light when the transmission device is in operation,
means of modulation that effect modulation of the light emitted by the at least one light source such that information can be transmitted by means of the light,
wherein the light from the at least one light source is modulated for information transmission only when the information to be transmitted belongs to a category corresponding to a wavelength spectrum of the light from the at least one light source.

7. The transmission device in accordance with claim 6, wherein the at least one light source takes the form of at least one of light emitting diode (LED) and a laser.

8. The transmission device in accordance with claim 6, wherein the transmission device comprises several light sources, where during operation of the transmission device, at least a first one of the several light sources transmits red light, at least a second one of the several light sources transmits green light, and at least a third one of the several light sources transmits blue light.

9. The transmission device in accordance with claim 7, wherein the transmission device comprises means of mixing the light emitted by the light sources such that white light is emitted by the transmission device.

10. A receiver device for use with a transmission device of claim 6 in a communications system, the receiver device comprising:
sensor means to capture light emitted by the at least one light source of the transmission device, and
evaluation means that extracts information transmitted via the captured light through demodulation and decoding.
